(19) United States
(12) Patent Application Publication
(10) Pub. No.: US 2021/0016991 A1
(43) Pub. Date: Jan. 21, 2021

(54) REINFORCED WOOD FIBER CORE

(71) Applicant: Souhegan Wood Products Inc., Wilton, NH (US)

(72) Inventor: Randolph A. Dunn, Wilton, NH (US)

(21) Appl. No.: 17/060,512

(22) Filed: Oct. 1, 2020

Related U.S. Application Data
(62) Division of application No. 14/865,289, filed on Sep. 25, 2015.
(60) Provisional application No. 62/055,164, filed on Sep. 25, 2014.

(51) Int. Cl. B65H 75/10; B65H 75/50

(52) U.S. Cl. CPC B65H 75/10; B32B 1/08; B65H 75/50

(57) ABSTRACT

A winding core with improved beam and hoop strength and diminished friability and method for manufacturing such a core are provided, the winding core comprising: an extruded wood fiber core member; and at least one preformed paper shell member having a split seam parallel to its major axis, the shell being adhered to an exterior surface of the extruded wood fiber core member.

### RELATED APPLICATIONS

This application is a divisional of U.S. application Ser. No. 14/865,289 filed Sep. 25, 2015 which claims the benefit of U.S. Provisional Application No. 62/055,164, filed Sep. 25, 2014. This application is herein incorporated by reference in its entirety for all purposes.

### FIELD OF THE INVENTION

The invention relates to extruded wood fiber winding cores, and more particularly, to an extruded wood fiber winding core equipped with a rigid paperboard coating.

### BACKGROUND OF THE INVENTION

Wood fiber cores are used to support rolls of various materials. Its limited beam strength and durability, however, have hindered its adoption in some industries like industrial belt winding, were the significant weight of the material wound about a core has traditionally been considered to require a steel core. Such steel cores are custom welded geographically close to the place where they will be used since they are bulky and awkward to transport. They are thus very costly.

Other industries, like light weight high tech non-woven materials have rejected such cores due to the friability of the wood fiber material. Dislodged material may damage the non-woven textile.

What is needed, therefore, are techniques for producing a light weight, non-friable, industrial core with a smooth exterior and high beam strength.

### SUMMARY OF THE INVENTION

One embodiment of the present invention provides a winding core, the winding core comprising: an extruded wood fiber core member; and at least one preformed paper shell member having a split seam parallel to its major axis, the shell being adhered to an exterior surface of the extruded wood fiber core member.

Another embodiment may provide such a core further comprising a second pre-formed paper shell member. In a further embodiment, the split seam of said first pre-formed paper shell member is offset from a split seam of said second pre-formed paper shell member. In yet another embodiment, such an offset is 180 degrees. In a yet further embodiment, that offset is 90 degrees. In even another embodiment, the first preformed paper shell member is between approximately 90/1000 inch-200/1000 inch thick.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a perspective view illustrating a reinforced winding core configured in accordance with one embodiment of the present invention.

FIG. 2 is a perspective view illustrating a reinforced winding core configured in accordance with one embodiment of the present invention having a multilayer shell with 90° out of phase seams.

FIG. 3 is a perspective view illustrating a reinforced winding core configured in accordance with one embodiment of the present invention having a multilayer shell with 180° out of phase seams.

FIG. 4 is a flow chart illustrating method for manufacturing a reinforced winding core configured in accordance with one embodiment of the present invention.

### DETAILED DESCRIPTION

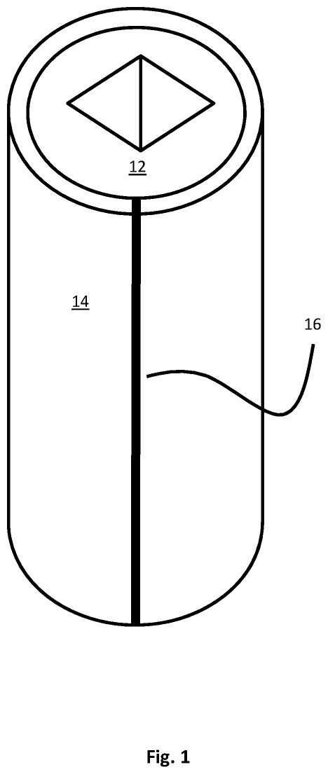

In one embodiment of the present invention, illustrated in FIG. 1 a wood fiber winding core 12 is provided such as those which have been manufactured by the applicant's company since 1963. An external shell 14 applied to the winding core 12. The external shell 14 of one such embodiment comprises a preformed cylindrical cardboard shell or shell of laminated paper. The shell is split 16 along at least one side to allow placement over the core 12. In one embodiment of the present invention, the inside diameter of the external shell is slightly smaller than the exterior diameter of the core to which it is applied such that there are no gaps between the exterior of the core and the interior of the shell once applied.

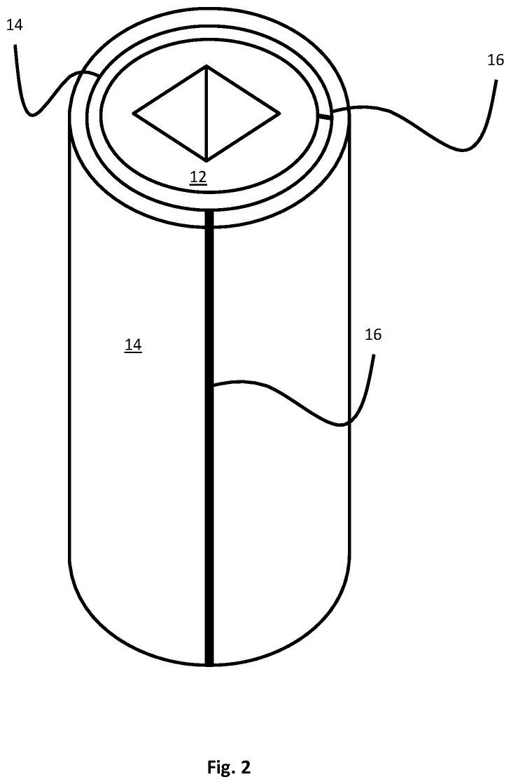

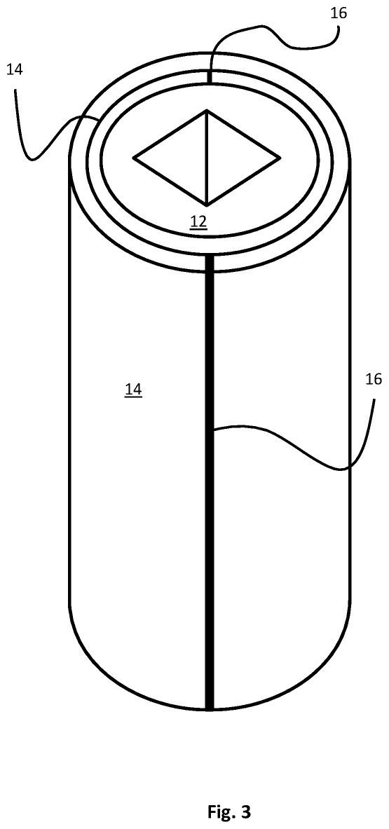

The external shell 14 of one embodiment of the present invention, is, as discussed above, configured from paper laminate, comprising layers of liner board that have been wound and formed into a cardboard like material. Examples of such tubes include those used to pour cement columns and footings. The thickness of the tubes may vary depending on the application, but in one embodiment may be approximately 90/1000 inch-200/1000 inch. Multiple layers of tubes may be applied to provide greater thickness of shells, in some instances up to 500/1000 inch to 600/1000 inch. In such embodiments with multiple layers increases in strength are seen in embodiments with staggered seams. The embodiments with greater demands for hoop strength would be provided with seams that are 180° out of phase as in FIG. 3, while those with greater need for beam strength would have seams 90° out of phase as in FIG. 2.

The shell may in some embodiments be affixed to the exterior of the core through glue or other chemical fastener. In one embodiment, wood glue is used. It has been found that embodiments using higher viscosity glues work well as they fill gaps in the extruded core. In other embodiments the core can be submersed in a bath of thinner bodied glue or resin to permeate the surface of the core and then the shell is applied. Alternative adhesives, such as epoxies or contact cements, may be used in various embodiments.

In embodiments using glues as adhesives, one or more may be applied to the exterior of the shell. The clamps may take the form of a plurality of hose clamps, a compressed air bag system, or a single vacuum bag enclosing the glued unit until the adhesive sets. An even pressure on the exterior of the shell is, according to one embodiment, used.

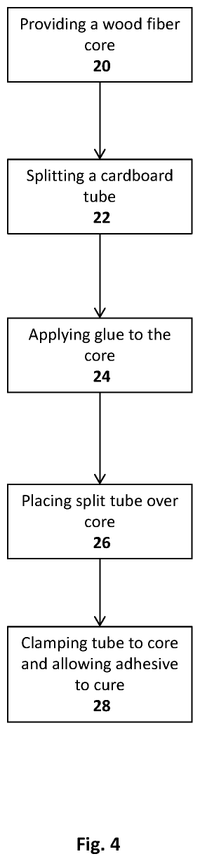

A method for manufacturing a winding core configured according to one embodiment of the present invention is illustrated in FIG. 4. A wood fiber core is provided having a cylindrical exterior cross profile and an interior axial aperture and extruded wood fiber body 20. A cardboard tube manufactured from a series of layers of linerboard is split along at least one side 22. The splitting of the cardboard tube may be done using sheers, knives, or other means by which a smooth, non-frayed edge cut is obtained. In other embodiments, more than one split may be made to facilitate application of stiffer tubes. The split tubes are configured to have an internal diameter that is smaller than the exterior diameter of the core. This may be achieved by selecting a tube for splitting which already has a smaller interior diameter, or removing material from the cut, thereby decreasing the internal diameter of the tube. Glue or other adhesive is applied to the core. 24 The split tube is then opened, applied, and disposed around the glued core and closed. 26 Clamps or other pressure devices are applied to the exterior of the tube to hold it securely in place until the adhesive cures. 28

The applicant has found that the application of a cardboard or paper tube to the exterior of a wood fiber core member yields a unit with high beam strength and minimal friability.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

I claim:

1. A winding core, the winding core comprising:
An extruded wood fiber core member;
At least a first pre-formed paper shell member having a split seam parallel to its major axis, said shell being adhered to an exterior surface of said extruded wood fiber core member.

2. The winding core of claim 1 further comprising a second pre-formed paper shell member.

3. The winding core of claim 2 wherein said split seam of said first pre-formed paper shell member is offset from a split seam of said second pre-formed paper shell member.

4. The winding core of claim 3 wherein said offset is 180 degrees.

5. The winding core of claim 3 wherein said offset is 90 degrees.

6. The winding core of claim 1 wherein said first preformed paper shell member is between approximately 90/1000 inch-200/1000 inch thick.
